(19) United States
(12) Patent Application Publication
(10) Pub. No.: US 2014/0120932 A1
(43) Pub. Date: May 1, 2014

(54) Method and System for Improving Performance of a Femtocell Self Organizing Network

(71) Applicant: BROADCOM CORPORATION, Irvine, CA (US)

(72) Inventor: Rafael CARMON, Rishon Lezion (IL)

(73) Assignee: Broadcom Corporation, Irvine, CA (US)

(21) Appl. No.: 13/749,174

(22) Filed: Jan. 24, 2013

Related U.S. Application Data
(60) Provisional application No. 61/719,278, filed on Oct. 26, 2012.

(51) Int. Cl. H04W 72/04

(52) U.S. Cl. CPC H04W 72/044
USPC 455/452.1

(57) ABSTRACT

Femtocells in a self-organizing network (SON) sniff their wireless fidelity (WiFi) environments to identify WiFi footprints of the femtocells. The WiFi footprints of each femtocell are sent to a femtocell gateway. The femtocell gateway receives WiFi footprint data from a plurality of femtocells and determines if there is a common WiFi footprint between the femtocells. The femtocells with exclusive WiFi footprints are allocated the same network parameters. The femtocells with common WiFi footprint are allocated different network parameters.

### CROSS-REFERENCE TO RELATED APPLICATION

This patent application claims the benefit of U.S. Provisional Patent Application No. 61/719,278 filed Oct. 26, 2012, entitled “Method and System for Improving Performance of a Femtocell Self Organizing Network,” which is incorporated herein by reference in its entirety.

### BACKGROUND

1. Field

The present disclosure relates generally to a self organizing network, and more specifically to a femtocell self organizing network.

2. Background

Cellular networks generally include a collection of macro base stations. The macro base stations typically transmit at relatively higher power (for example, 10 W-70 W) to maximize coverage. The physical locations of macro base stations are planned ahead and the macro base stations are configured either individually or in a group to support handovers/handoffs between them.

As cellular technologies evolve (for example, 2G-->2.5G-->3G-->4G; GSM, GPRS, CDMA, Ev-DO, UMTS, HSPA, WiMAX, LTE), low power base stations (for example, femtocells or small cells) that are more localized are being deployed. A femtocell or a small cell is a low power, limited coverage, and limited capacity base station which can be used for both residential and enterprise deployments.

Femtocells generally use a “self organizing network” (SON) technique to support self configuration. A femtocell identifies other neighboring femtocells or base stations through a process called sniffing that detects wireless signals in the surrounding area. However, sniffing in the context of a femtocell self-organizing network (SON) has drawbacks. For example, a femtocell may not efficiently detect its neighbors as the overlapping between neighboring femtocells may not be large enough to permit detection.

### BRIEF DESCRIPTION OF THE FIGURES

Embodiments of the disclosure are described with reference to the accompanying drawings. In the drawings, like reference numbers indicate identical or functionally similar elements. Additionally, the left most digit(s) of a reference number identifies the drawing in which the reference number first appears.

FIG. 1 illustrates a femtocell self organizing network, in accordance with an embodiment.

FIG. 2 illustrates femtocells identifying WiFi footprints in a femtocell self organizing network, in accordance with an embodiment.

FIG. 3 is a flow diagram illustrating a mechanism for improving performance of a femtocell self organizing network, in accordance with an embodiment.

FIG. 4 is a diagram illustrating a computer system, in accordance with an embodiment.

The disclosure will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described can include a particular feature, structure, or characteristic, but every exemplary embodiment can not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are riot limiting. Other exemplary embodiments are possible, and modifications can be made to the exemplary embodiments within the spirit and scope of the disclosure. Therefore, the Detailed Description is not meant to limit the disclosure. Rather, the scope of the disclosure is defined only in accordance with the following claims and their equivalents.

The embodiments described herein provides for a mechanism to improve performance of a femtocell self organizing network (SON). In particular, a femtocell sniffs not only other base stations but also for WiFi networks transmitting signals into its coverage area. This is referred. to as the WiFi. footprint. WiFi footprint of a femtocell is a listing of WiFi networks detected by a femtocell during the sniffing process. Using the WiFi footprint of each femtocell in a SON, the femtocell SON can determine femtocells that likely overlap. For example, femtocells with exclusive WiFi footprints can be allocated the same network parameters. Femtocells with overlapping WiFi footprints can be allocated different network parameters.

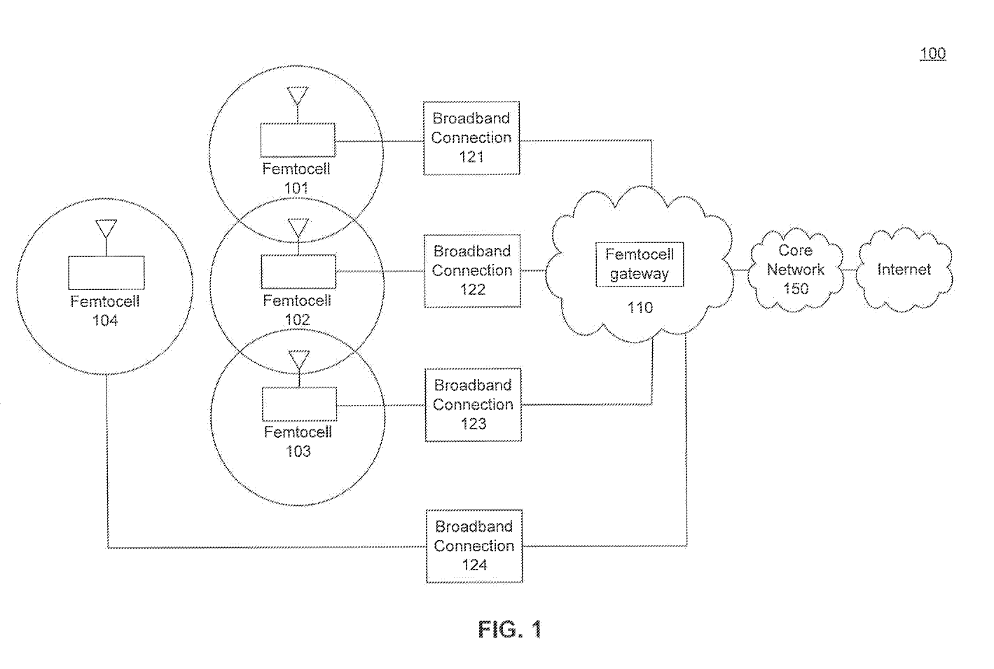

FIG. 1 illustrates a femtocell self organizing network (SON) 100, in accordance with an embodiment. Network 100 includes one or more femtocells 101, 102, 103, and 104. Femtocells 101-104 can be standard femtocells used to extend service coverage indoors or at the edge of a cell in a cellular network, particularly where coverage may be limited or unavailable. A femtocell or a femtocell access point is a small, low powered cellular base station typically designed for use in a home or a business. It typically connects to a service provider's network via a broadband connection 121-124. Broadband connection 121-124 can be a broadband wired connection, for example, digital subscriber line (DSL), cable, or fiber optic service (FiOS). A femtocell can support communication with wireless devices through an air interface, for example, GSM, CDMA, Ev-DO, UMTS, HSPA, HSPA+ or LTE air interface.

Femtocells can provide improved coverage and capacity, especially indoors. A femtocell may operate in W-CDMA, GSM, CDMA, 3G, WiMAX, LTE, or any other currently available or future developed wireless communications standards. A femtocell can typically support between two to sixteen wireless devices, for example, personal computers, cellular phones, tablets, etc. However, the number of wireless devices supported can support additional devices and depends on the hardware and/or software configuration of the femtocell or location of the femtocell.

Femtocells that are in close proximity to one another in a SON can interfere with each another. Thus, it is important for each femtocell to identify other neighboring femtocells. This can be performed by sniffing. Femtocells can use sniffing to determine, for example, network parameters used by neighboring femtocells. Network parameters are typically re-used in a network due to their limited availability. Examples of network parameters that are generally re-used include a color code, a scrambler code, a ZC sequence or a cell_id. Femtocells that use the same network parameters should be separated by a sufficient distance to avoid interference. A femtocell within a SON can configure itself with network parameters different from its neighboring cells, which allows it to support various network functions, for example, handovers, timing, synchronization, etc. without interference from neighboring cells.

Using sniffing to self-configure a femtocell has drawbacks. For example, a a femtocell may not be able to detect its neighbors for a variety of reasons. These drawbacks can be addressed by moving allocation of femtocell network parameters to a centralized femtocell gateway 110.

Femtocells 101-104 are coupled to femtocell gateway 110 over a network. in an embodiment, a femtocell gateway 110 is femtocell gateway management system or a Home Node-B Management system (HMS). Femtocell gateway 110 connects to one or more networks such as service provider's core network 150 or a public communications network such as the Internet. A femtocell gateway 110 or a HMS is configured to receive the results of sniffing from the femtocells and to allocate distinct network parameters to neighboring femtocells thus avoiding the problem of interfering femtocells, However, this approach may fail in areas with high density femtocell deployments. In these areas, a femtocell may fall to identify a neighboring femtocell if there is no overlap in the coverage area or the overlap in coverage area is not enough to identify a neighboring femtocell. For example, a femtocell located on the third floor of a building may not be able to sniff a femtocell (or any other cell) located on the fifteenth floor of the same building. This may result in the femtocell gateway assigning the same network parameters to neighboring femtocells causing, for example, user equipment (UE) handover failures affecting performance of a femtocell SON.

As shown in FIG, 1, femtocells 101 and 102 are neighbors with overlapping coverage. Femtocell 102 has femtocells 103 and 104 as neighbors with overlapping coverage. Femtocells 104 and 102 are neighbors with no overlapping coverage. As shown in FIG. 1, femtocell 104 has no overlapping coverage with any of femtocells 101-103.

Femtocell gateway 110 is a network node that can secure network connectivity between femtocells and core network 150 by allowing femtocells to communicate with the core network in an operator's cellular network. Femtocell gateway 110 can use standard Internet security protocols, for example, Internet Protocol Security (IPSec), to authenticate and authorize femtocells and provide encryption support for signaling and user traffic. Femtocell gateway 110 can also support a large number of femtocells connecting to core network 150.

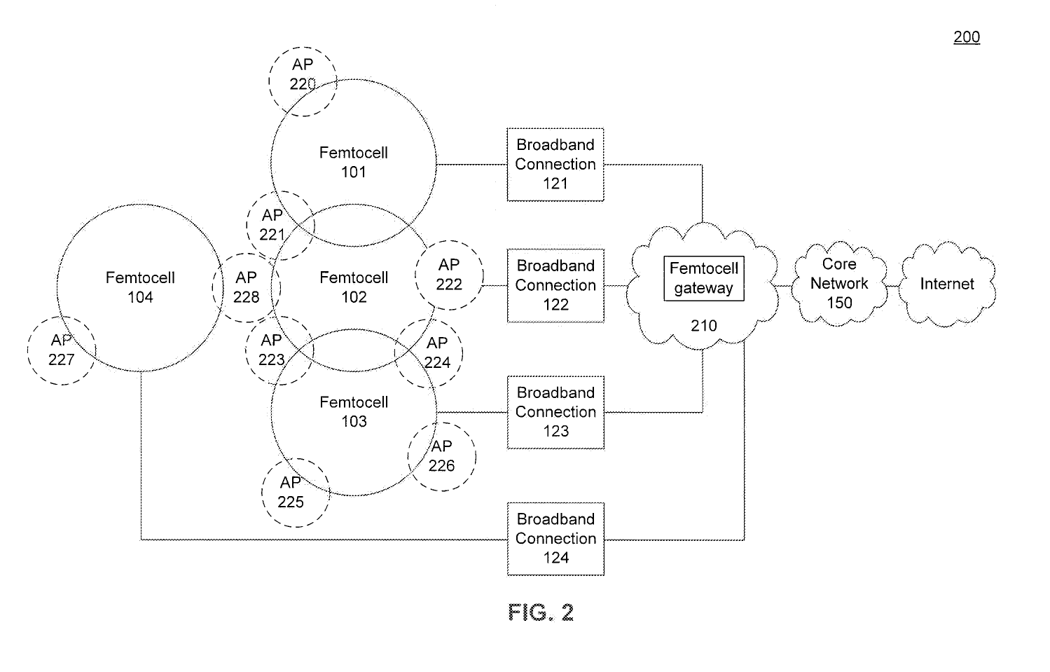

FIG. 2 illustrates a system for identifying WiFi footprints within a femtocell in a femtocell self organizing network 200, in accordance with an embodiment. In addition to femtocells, network 200 includes one or more WiFi networks 220-227. Each WiFi network includes an access point (AP). A wireless access point (AP) is a device that allows wireless devices to connect to a wired network using Wi-Fi or related standards. Like a femtocell network, a WiFi network includes parameters that are used to establish communication and handoff of user devices. Femtocells 101-104 perform sniffing of their respective WiFi environments to detect their WiFi networks active in their coverage areas. The WiFi footprint of a femtocell includes a listing of these detected WiFi networks. Like a femtocell network, a WiFi network includes parameters that are used to establish communication and handoff of user devices. The WiFi footprint includes one or more of these WiFi parameters.

For example, femtocell 101 performs sniffing to identify its WiFi footprint and detects WiFi networks 220 and 221. Femtocell 102 performs sniffing to identify its WiFi footprint and detects WiFi networks 221, 222, 223, 224, and 228. Femtocell 103 performs sniffing to identify its WiFi footprint and detects WiFi networks 223, 224, 225, and 226. Femtocell 104 performs sniffing to identify its WiFi footprint and detects WiFi networks 227 and 228.

The WiFi footprints of each femtocell 101-104 are sent to femtocell gateway 210.

Femtocell gateway 210 is configured to identify WiFi networks that are common to WiFi footprints of the femtocells by analyzing the received WiFi parameters of the WiFi networks in the WiFi footprints. WiFi parameters that can be used for identification of a WiFi network can include, for example, a network id, an encryption type, a radio frequency (RF) band and a RF carrier.

Femtocell gateway 210 can be, for example, a central server or a femtocell gateway management system. In an embodiment, the femtocell gateway 210 can be located in core network 150 of a service provider's network or located in a stand-alone server inside or outside the core network of a service provider's cellular network. In an embodiment, femtocell gateway 210 management system can be co-located with other entities in the same server.

After analyzing the WiFi footprints of the femtocells, femtocell gateway 210 identifies femtocells with exclusive WiFi footprints (for example, no common WiFi networks in the WiFi footprints). Because these femtocell are likely not overlapping or neighboring, the femtocell gateway 210 can allocate the same network attributes to these femtocells with low risk of interference. For example, femtocells 101 and 103 have exclusive footprints as described above as they do not have any WiFi networks common in their WiFi footprints. Therefore, the network parameters can be re-used for femtocells 101 and 103. When there is at least one WiFi network that is common to WiFi footprints of femtocells, different network parameters can be assigned as the femtocells may be neighbors. It is contemplated that any number of overlapping WiFi networks can be used to make a determination that a different set of network parameters to be assigned to neighboring femtocells.

Femtocell gateway 210 can also take into account other factors into consideration when assessing whether two femtocells are neighboring based on their WiFi footprint In an embodiment, a network operator may configure a threshold value for the number of common WiFi networks required to indicate femtocells are neighboring. For example, if a network operator configures the threshold value as “two,” femtocell gateway 210 may not allocate the same network attributes to femtocell if there are more than two WiFi networks common to the WiFi footprints of the femtocells. In an embodiment, additional considerations may be taken into account, for example, traditional cellular sniffing, density of femtocell deployment, and availability of network parameters. In a further example, femtocells 102 and 103 have WiFi 223 and 224 common to their WiFi footprints. If the same network parameters are assigned to femtocells 102 and 103, UE handovers, for example, between femtocells 102 and 103 may fail. Therefore, the same network parameters may not be assigned to femtocells 102 and 103.

For example, femtocells 102 and 104 are neighbors with no overlapping coverage. WiFi network 228 is common to WiFi footprints of femtocells 102 and 104, femtocell gateway 210 may assign the same network parameters to femtocells 102 and 104 if the threshold value described above is configured the network operator at a value of two. Additionally, femtocell gateway 210 may take other factors into consideration prior to allocating the same network parameters to neighboring femtocells to avoid performance issues in the network.

In an embodiment, WiFi footprint of a femtocell can also be cross-checked with a hotspot location database for additional location information. For example, a hotspot location database may provide additional information with regard to location of a WiFi network. In an embodiment, National, Metro or WiFi networks or WiFi hotspots with common default names (for example, Big Company WiFi or Free WiFi, Apartment WiFi, Hotel WiFi) are not used in the analysis to identify a common WiFi footprint to improve accuracy of identification of common WiFi footprint.

In an embodiment, femtocell gateway 210 can also use other data in its analysis. For example, handover operational measurements (OMs), femtocell location data, GPS locations etc. can be used in addition to WiFi footprint to ensure that neighboring cells are not assigned the same network parameters essential to support network functionality.

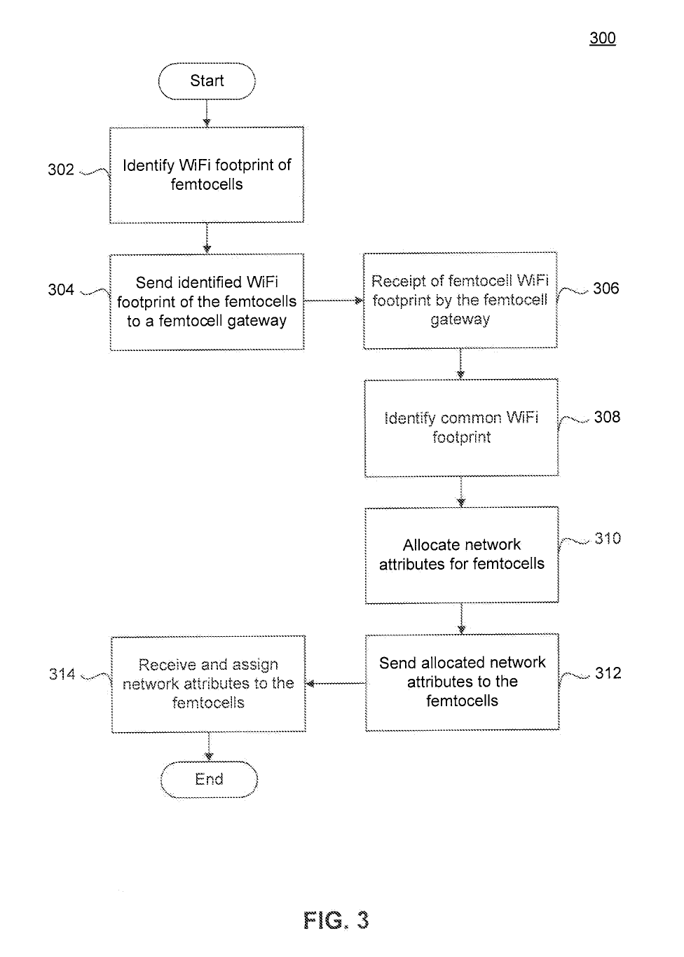

FIG. 3 is a flow diagram illustrating a method 300 to improve performance of a femtocell self organizing network, in accordance with an embodiment.

At operation 302, femtocells 101-104 perform sniffing to identify WiFi networks operating within their respective femtocell and generates the WiFi footprint for the femtocell. For example, femtocell 101 performs sniffing and identifies WiFi networks/APs 220 and 221 in its WiFi footprint. Femtocell 102 performs sniffing and identifies WiFi networks 221, 222, 223, 224 and 228 in its WiFi footprint. Femtocell 103 performs sniffing and identifies WiFi networks 223, 224, 225 and 226 in its WiFi footprint. Femtocell 104 performs sniffing and identifies WiFi networks and 227 and 228 in its WiFi footprint. Although, the disclosure is explained in the context of sniffing by femtocells to identify their WiFi footprints, a person skilled in the relevant art will understand that there are other techniques that can be used to identify a WiFi footprint of a femtocell.

At operation 304, each femtocell sends its identified WiFi footprint to femtocell gateway 210. For example, femtocells 101-104 send their WiFi footprints to femtocell gateway 210. In an embodiment, the femtocells may process and format the identified WiFi footprint prior to sending to femtocell gateway 210.

At operation 306, femtocell gateway 210 receives the WiFi footprints of the femtocells and processes the received information. For example, femtocell gateway 210 processes the received Wifi footprints from each of the femtocells and identifies the WiFi networks identified through sniffing. In an embodiment, femtocell gateway 210 may perform some mapping to identify the femtocells and/or WiFi networks using information stored in a database of femtocell gateway 210. For example, the database may contain location information of the femtocells and/or WiFi networks.

At operation 308, femtocell gateway 210 identifies common WiFi networks between the WiFi footprints of the femtocells by analyzing WiFi parameters of each of the WiFi networks in the WiFi footprints. The analysis of WiFi footprints to identify common WiFi footprints is described above with reference to FIG. 2. For example, if there are no common WiFi networks in their WiFi footprints, femtocell gateway 210 allocated the same network attributes to the femtocells. For example, if common WiFi networks are presents in the WiFi footprints of two femtocells, femtocell gateway 210 may consider the femtocells as neighbors, and may allocate different network parameters. In an embodiment, the threshold factor described above can be used and configured by the network operator.

At operation 310, femtocell gateway 210 determines network parameters to be allocated to the femtocells. This can be performed by searching the database of femtocell gateway and identifying available network parameters. Once the network parameters to be allocated are identified, femtocell gateway 210 allocates them to the femtocells and marks them as allocated in its database. In an embodiment, femtocell gateway 210 may send a message to femtocells to initiate a sniff of a femtocell's environment and transmit the results of sniffing to femtocell gateway 210.

At operation 312, femtocell gateway 210 sends the allocated network parameters to the femtocells to be assigned to the femtocells.

At operation 314, femtocells receive the allocated network parameters and assign them to the femtocells.

The mechanism described above can avoid assigning the same network attributes to neighboring femtocells in a femtocell SON. This will improve the performance of a femtocell self organizing network.

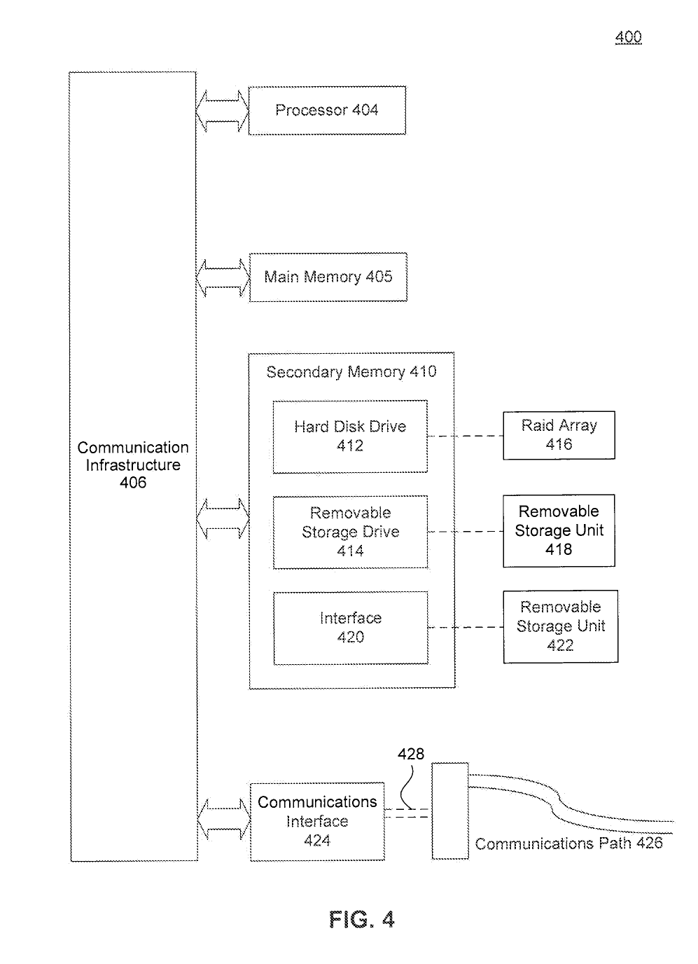

FIG. 4 illustrates a system 400 which may include one or more computer systems, in which embodiments, or portions thereof, may be implemented as computer-readable code. For example, femtocell gateway 210 may be described in terms of being computer system 400. Also, flowchart 300 can be implemented using one or more computer systems 400.

The embodiments presented herein apply to any communication system between two or more devices or within subcomponents of one device. The representative functions described herein can be implemented in hardware, software, or some combination thereof. For instance, the representative functions can be implemented using computer processors, computer logic, application specific circuits (ASIC), digital signal processors, etc., as will be understood by those skilled in the arts based on the discussion given herein. Accordingly, any processor that performs the functions described herein is within the scope and spirit of the embodiments presented herein.

The following describes a general purpose computer system that can be used to implement embodiments of the disclosure presented herein. The present disclosure can be implemented in hardware, or as a combination of software and hardware. Consequently, the disclosure may be implemented in the environment of a computer system or other processing system. An example of such a computer system 400 is shown in FIG. 4. The computer system 400 includes one or more processors, such as processor 404. Processor 404 can be a special purpose or a general purpose digital signal processor. The processor 404 is connected to communication infrastructure 406 (for example, a bus or network). Various software implementations are described in terms of this exemplary computer system. After reading this description, it will become apparent to a person skilled in the relevant art how to implement the disclosure using other computer systems and/or computer architectures.

Computer system 400 also includes a main memory 405, preferably random access memory (RAM), and may also include a secondary memory 410, The secondary memory 410 may include, for example, a hard disk drive 412, and/or a RAID array 416, and/or a removable storage drive 414, representing a floppy disk drive, a magnetic tape drive, an optical disk drive, etc. The removable storage drive 414 reads from and/or writes to a removable storage unit 418 in a well-known manner, Removable storage unit 418, represents a floppy disk, magnetic tape, optical disk, etc. As will be appreciated, the removable storage unit 418 includes a computer usable storage medium having stored therein computer software and/or data.

In alternative implementations, secondary memory 410 may include other similar means for allowing computer programs or other instructions to be loaded into computer system 400, Such means may include, for example, a removable storage unit 422 and an interface 420. Examples of such means may include a program cartridge and cartridge interface (such as that found in video game devices), a removable memory chip (such as an EPROM, or PROM) and an associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices, Examples of communications interface 424 may include a modem, a network interface (such as an Ethernet card), a communications port, a PCMCIA slot and card, etc. Software and data transferred via communications interface 424 are in the form of signals 428 which may be electronic, electromagnetic, optical or other signals capable of being received by communications interface 424. These signals 428 are provided to communications interface 424 via a communications path 426. Communications path 426 carries signals 428 and may be implemented using wire or cable, fiber optics, a phone line, a cellular phone link, an RF link and other communications channels.

The terms “computer program medium” and “computer usable medium” are used herein to generally refer to media such as removable storage drive 414, a hard disk installed in hard disk drive 412, and signals 428. These computer program products are means for providing software to computer system 400.

Computer programs (also called computer control logic) are stored in main memory 405 and/or secondary memory 410. Computer programs may also be received via communications interface 424. Such computer programs, when executed, enable the computer system 400 to implement the present disclosure as discussed herein. In particular, the computer programs, when executed, enable the processor 404 to implement the processes of the present disclosure. For example, when executed, the computer programs enable processor 404 to implement part of or all of the steps described above with reference to the flowcharts herein. Where the disclosure is implemented using software, the software may be stored in a computer program product and loaded into computer system 400 using raid array 416, removable storage drive 414, hard drive 412 or communications interface 424.

In other embodiments, features of the disclosure are implemented primarily in hardware using, for example, hardware components such as Application Specific Integrated Circuits (ASICs) and programmable or static gate arrays, Implementation of a hardware state machine so as to perform the functions described herein will also be apparent to persons skilled in the relevant art(s).

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. For example, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. For example, such adaptations and modifications are intended to be within the meaning and range of equivalents of the disclosed embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

Furthermore, a person skilled in the relevant art will understand how to implement the embodiments describe herein using other software, hardware, firmware, and/or operating system implementations other than those described herein. Therefore, any software, hardware, firmware, and operating system implementations suitable for performing the functions described herein can be used.

What is claimed is:

1. A method for improving performance of a femtocell self organizing network, comprising:
receiving wireless fidelity (WiFi) footprints from a first femtocell and a second femtocell;
determining whether there is a common WiFi footprint between the WiFi footprints of the first femtocell and the second femtocell; and
allocating one or more network parameters to the first femtocell or the second femtocell based at least on the determining.

2. The method of claim 1, wherein the receiving, the determining and the allocating are performed by a femtocell gateway.

3. The method of claim 2, wherein the femtocell gateway is a Home NodeB Management System (HMS).

4. The method of claim 2, wherein the femtocell gateway is located in a core network.

5. The method of claim 2, wherein the femtocell gateway is co-located with other entities in a single server.

6. The method of claim 1, wherein the determining comprises:
retrieving WiFi parameters from the WiFi footprints; and
analyzing the retrieved WiFi parameters to identify parameters that are common to the WiFi footprints.

7. The method of claim 6, wherein the retrieving comprises retrieving one or more WiFi parameters from a list comprising a network id, an encryption type, a radio frequency (RF) band and a RF carrier.

8. The method of claim 1, wherein the network parameters are from a list comprising a color code, a scrambler code, a ZC sequence and a cell_id.

9. A method for improving performance of a femtocell self organizing network, comprising:
identifying a wireless fidelity (WiFi) footprint of a femtocell, wherein the WiFi footprint of the femtocell comprises one or more WiFi networks;
sending the identified WiFi footprint to a femtocell gateway; and
receiving one or more network parameters from the femtocell gateway.

10. The method of claim 9, further comprising:
assigning the received network parameters to the femtocell.

11. The method of claim 9, wherein the network parameters received from the femtocell gateway are from a list comprising a color code, a scrambler code, a ZC sequence and a cell_id.

12. The method of claim 9, wherein the identifying comprises sniffing a WiFi environment of a femtocell to detect the one or more WiFi networks.

13. A femtocell gateway device for improving performance of a femtocell self organizing network, comprising:
one or more circuits configured to:
receive wireless fidelity (WiFi) footprints from a first femtocell and a second femtocell;
determine whether there is a common WiFi footprint between the footprints of the first femtocell and the second femtocell; and
allocate one or more network parameters to the first femtocell or the second femtocell based at least on whether there is a common WiFi footprint.

14. The device of claim 13, wherein the femtocell gateway is a Home NodeB Management System (HMS) as defined in 3GPP specification.

15. The device of claim 13, wherein the femtocell gateway is located in a core network.

16. The device of claim 13, wherein the femtocell gateway is co-located with other entities in a single server.

17. The device of claim 13, the one or more circuits further configured to:
send a message to femtocells to initiate a sniff and send WiFi footprint data.

18. The device of claim 13, the one or more circuits further configured to:
retrieve WiFi parameters of the received footprints; and
analyze the retrieved WiFi parameters to identify parameters that are common to the WiFi footprints.

19. The device of claim 13, wherein the femtocell gateway retrieves one or more WiFi parameters from a list comprising a network id, an encryption type, a radio frequency (RF) band and a RF carrier.

20. The device of claim 13, wherein the network parameters are from a list comprising a color code, a scrambler code, a ZC sequence and a cell_id.
